(19) United States
(12) Patent Application Publication
(10) Pub. No.: US 2026/0316849 A1
(43) Pub. Date: Oct. 15, 2026

(54) MOBILE BODY AND CONTROL DEVICE THEREFOR

(71) Applicant: HONDA MOTOR CO., LTD., Tokyo (JP)

(72) Inventors: Kazumasa OZAKI, Saitama (JP); Makoto HASEGAWA, Saitama (JP)

(21) Appl. No.: 19/466,864

(22) Filed: Feb. 2, 2026

(30) Foreign Application Priority Data
Mar. 31, 2025 (JP) 2025-059601

(51) Int. Cl. B62D 37/00; B60B 19/00; B62D 11/00; B62D 61/12

(52) U.S. Cl. CPC B62D 37/00; B60B 19/003; B62D 11/003; B62D 61/12

(57) ABSTRACT

A mobile body, includes: a main body; an omnidirectional wheel provided on the main body; and a control device configured to control the omnidirectional wheel, wherein the control device is configured to: monitor an abnormality in the mobile body; under normal circumstances, calculate target values including a target front-rear translational speed, a target lateral translational speed, and a target turning speed of the mobile body based on inverted pendulum control and control the omnidirectional wheel based on the target values; and when an abnormality is detected, stop calculation of the target values and control the omnidirectional wheel for a predetermined period from detection of the abnormality based on latest values of the target values calculated immediately before the detection of the abnormality or values obtained by gradually decreasing the latest values.

### TECHNICAL FIELD

The present invention relates to a mobile body and a control device therefor.

### BACKGROUND ART

Conventionally, an inverted pendulum mobile body as disclosed in JP7332536B2 is known. The mobile body includes a main body, a pair of omnidirectional wheels provided on the main body, and a control device that controls the pair of omnidirectional wheels. The control device maintains the posture of the mobile body by performing inverted pendulum control.

In the mobile body as mentioned above, an abnormality that makes it impossible to continue the inverted pendulum control may occur. The abnormality occurs when the center of gravity of the occupant moves to such an extent that a driving force beyond the maximum driving force that can be outputted by the omnidirectional wheels is required or when a sensor necessary to perform the inverted pendulum control fails, for example. When such an abnormality occurs, if the control of the omnidirectional wheels is stopped suddenly, an overturning moment applied to the mobile body may increase. Therefore, the occupant is required to promptly cope with the stop of the inverted pendulum control.

### SUMMARY OF THE INVENTION

In view of the foregoing background, an object of one aspect of the present invention is to reduce the overturning moment produced when it becomes impossible to continue the inverted pendulum control in the mobile body.

To achieve the above object, one aspect of the present invention provides a mobile body, comprising: a main body; an omnidirectional wheel provided on the main body; and a control device configured to control the omnidirectional wheel, wherein the control device is configured to: monitor an abnormality in the mobile body; under normal circumstances, calculate target values including a target front-rear translational speed, a target lateral translational speed, and a target turning speed of the mobile body based on inverted pendulum control and control the omnidirectional wheel based on the target values; and when an abnormality is detected, stop calculation of the target values and control the omnidirectional wheel for a predetermined period from detection of the abnormality based on latest values of the target values calculated immediately before the detection of the abnormality or values obtained by gradually decreasing the latest values.

According to the above aspect, it is possible to reduce the overturning moment produced when it becomes impossible to continue the inverted pendulum control in the mobile body.

### BRIEF DESCRIPTION OF THE DRAWINGS

FIG. 1 is a side view of a mobile body according to an embodiment when a main body upper portion is in a high position;

FIG. 2 is a side view of the mobile body when the main body upper portion is in a low position;

FIG. 3 is an explanatory diagram showing the mobile body as viewed from the front;

FIG. 4 is a sectional view of an omnidirectional wheel;

FIG. 5 is a block diagram of a control device for the mobile body;

FIG. 6 is an explanatory diagram of an inverted pendulum model of the mobile body as seen in the Y-axis direction;

FIG. 7 is an explanatory diagram of the inverted pendulum model of the mobile body as seen in the X-axis direction;

FIG. 8 is a block diagram showing a target translational speed determination part;

FIG. 9 is a block diagram showing a center of gravity offset estimation part;

FIG. 10 is a block diagram showing a target turning speed determination part;

FIG. 11 is a block diagram showing an individual target translational speed determination part; and

FIG. 12 is a time chart showing a target lateral translational speed, a target turning speed, and a target front-rear translational speed in the event of an abnormality.

### DETAILED DESCRIPTION OF THE INVENTION

In the following, an embodiment of the mobile body 1 will be described with reference to the drawings. In the present embodiment, the mobile body 1 is configured as an inverted pendulum vehicle. In the following description, the front-rear direction of the mobile body 1 is referred to as the X-axis direction, the left-right direction of the mobile body 1 is referred to as the Y-axis direction, and the up-down direction of the mobile body 1 is referred to as the Z-axis direction.

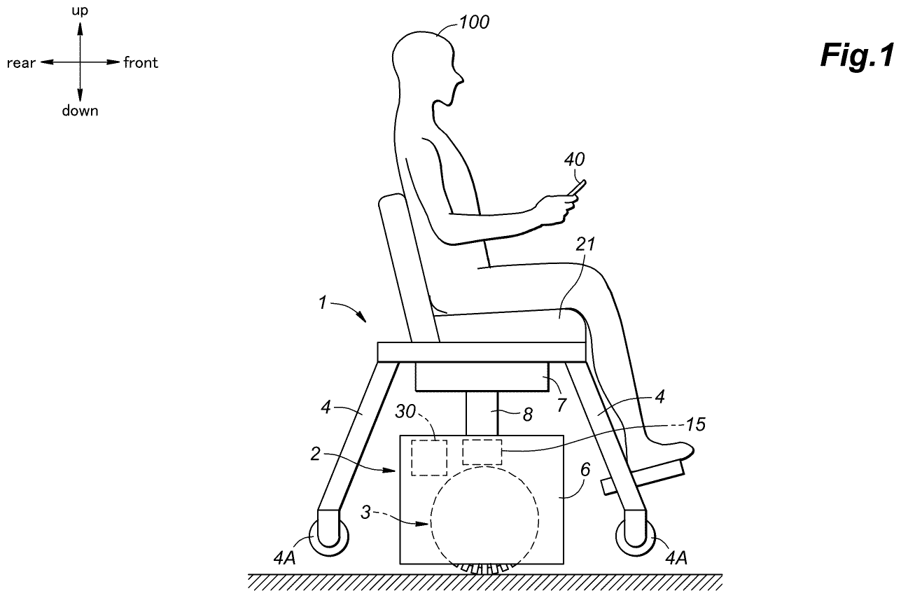

As shown in FIG. 1 to FIG. 3, the mobile body 1 includes a main body 2 and a pair of omnidirectional wheels 3 provided on the main body 2. The main body 2 is provided with multiple legs 4. The main body 2 includes a main body lower portion 6 that supports the pair of omnidirectional wheels 3 and a main body upper portion 7 provided above the main body lower portion 6. The multiple legs 4 are joined to the main body upper portion 7 and extend downward from the main body upper portion 7. Between the main body lower portion 6 and the main body upper portion 7, a lift device 8 for raising and lowering the main body lower portion 6 relative to the main body upper portion 7 between a low position and a high position is provided.

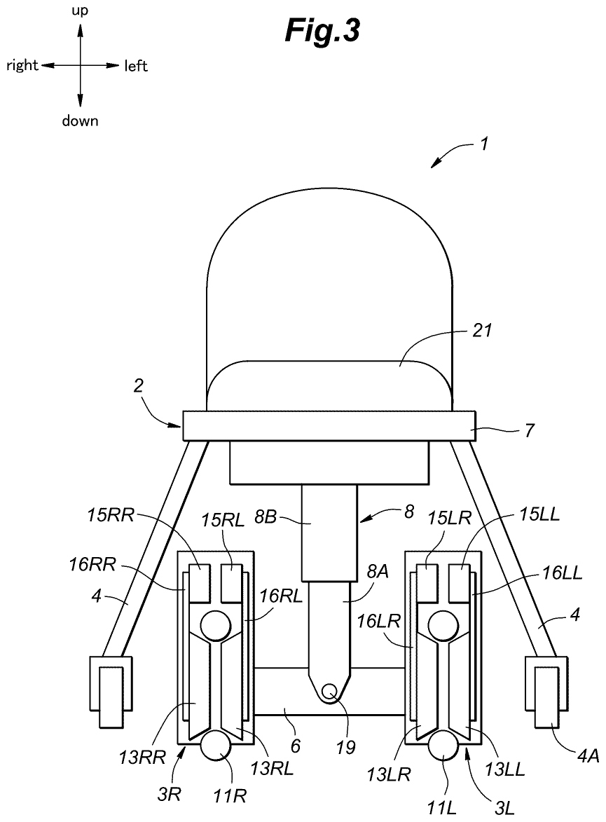

The pair of omnidirectional wheels 3 are provided on the left and right side portions of the main body lower portion 6. The pair of left and right omnidirectional wheels 3 have the same configuration. The omnidirectional wheels 3 may be also referred to as friction driving devices. Each omnidirectional wheel 3 includes a drive wheel 11 that is driven under the inverted pendulum control. As shown in FIG. 3, the omnidirectional wheel 3 includes a frame 12, a pair of left and right drive disks 13 rotatably supported on the frame 12, multiple drive rollers 14 rotatably supported on each of the drive disks 13, an annular drive wheel 11 disposed between the left and right drive disks 13 to be in contact with the drive rollers 14, and a pair of electric motors 15 for individually rotating the pair of drive disks 13.

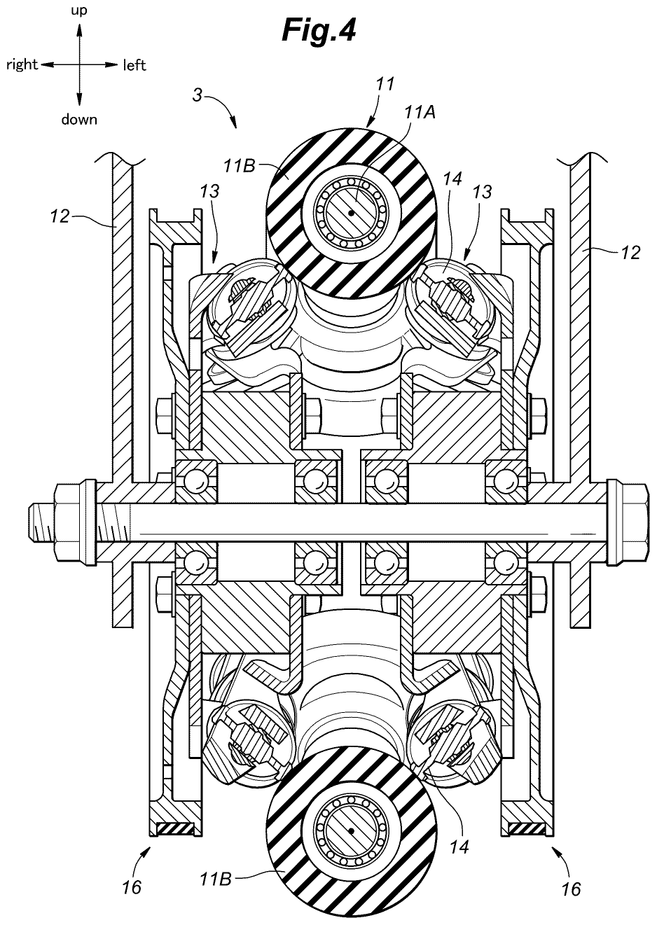

The pair of drive disks 13 are disposed to be coaxial with each other, and their rotation axes extend in the left-right direction (Y-axis direction). As shown in FIG. 3 and FIG. 4, each electric motor 15 is connected to the corresponding drive disk 13 via a transmission mechanism 16. The transmission mechanism 16 is preferably a belt transmission mechanism, for example. Each electric motor 15 is preferably disposed above the corresponding drive disk 13.

As shown in FIG. 4, the drive wheel 11 is annular in shape and is disposed between the pair of drive disks 13 to be coaxial with the drive disks 13. Also, the drive wheel 11 is in contact with the multiple drive rollers 14 and is rotatable about a central axis and about an annular axis. The drive wheel 11 includes a core 11A having a circular annular shape and multiple driven rollers 11B rotatably supported by the core 11A, for example. Each driven roller 11B is supported by the core 11A to be rotatable about an annular axis of the core 11A. Each driven roller 11B receives a load from the drive disks 13 and rotates relative to the core 11A.

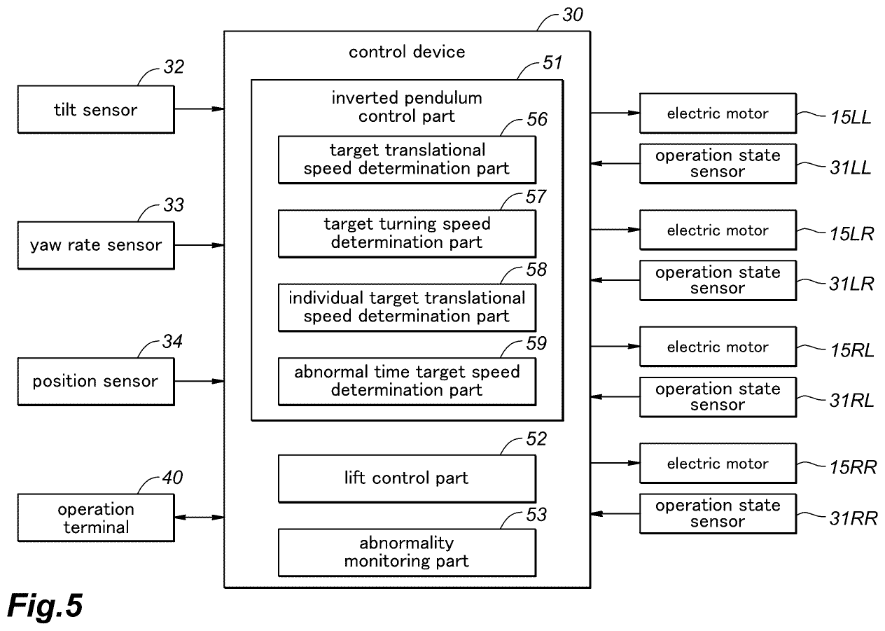

The left and right omnidirectional wheels 3 have an identical configuration. The left omnidirectional wheel 3 may be denoted by 3L by adding a suffix L. Also, the right omnidirectional wheel 3 may be denoted by 3R by adding a suffix R. Also, regarding the components provided as a left and right pair in the left omnidirectional wheel 3L, a suffix LL is added to the reference numeral for the left component and a suffix LR is added to the right component. Similarly, regarding the components provided as a left and right pair in the right omnidirectional wheel 3R, a suffix RL is added to the left component and a suffix RR is added to the right component. For example, as shown in FIG. 5, the left omnidirectional wheel 3L includes a left electric motor 15LL, a right electric motor 15LR, a left transmission mechanism 16LL, a right transmission mechanism 16LR, a left drive disk 13LL, a right drive disk 13LR, and a drive wheel 11L. Similarly, the right omnidirectional wheel 3R includes a left electric motor 15RL, a right electric motor 15RR, a left transmission mechanism 16RL, a right transmission mechanism 16RR, a left drive disk 13RL, a right drive disk 13RR, and a drive wheel 11R.

When the pair of drive disks 13 are turned in the same direction and at the same rotation speed in each omnidirectional wheel 3, the drive wheel 11 rotates together with the pair of drive disks 13. Namely, the drive wheel 11 rotates forward or backward about its own axis which corresponds with the rotation axis A. At this time, the drive rollers 14 on the drive disk 13 and the driven rollers 11B on the drive wheel 11 do not rotate relative to the core 11A. When there is a difference in the rotation speed between the pair of drive disks 13 in each omnidirectional wheel 3, a component force perpendicular to the circumferential (tangential) force produced by the rotation of the pair of drive disks 13 acts on the driven rollers 11B on the drive wheel 11 from the left and right drive rollers 14. Since the axis of each drive roller 14 is inclined relative to the circumferential direction of the drive roller 14, a component force is produced by the rotation speed difference between the drive disks 13. Due to this component force, the drive rollers 14 rotate, which in turn causes the driven rollers 11B to rotate relative to the core 11A. Thereby, the drive wheel 11 generates a driving force in the left-right direction.

When the left and right omnidirectional wheels 3 rotate forward at the same speed, the mobile body 1 moves forward. When the left and right omnidirectional wheels 3 rotate backward at the same speed, the mobile body 1 moves backward. When a difference occurs in the rotation speed in the front-rear direction between the left and right omnidirectional wheels 3, the mobile body 1 turns right or left. By rotating the driven rollers 11B of the drive wheel 11 of each of the left and right omnidirectional wheels 3, the mobile body 1 can undergo rightward or leftward translational movement.

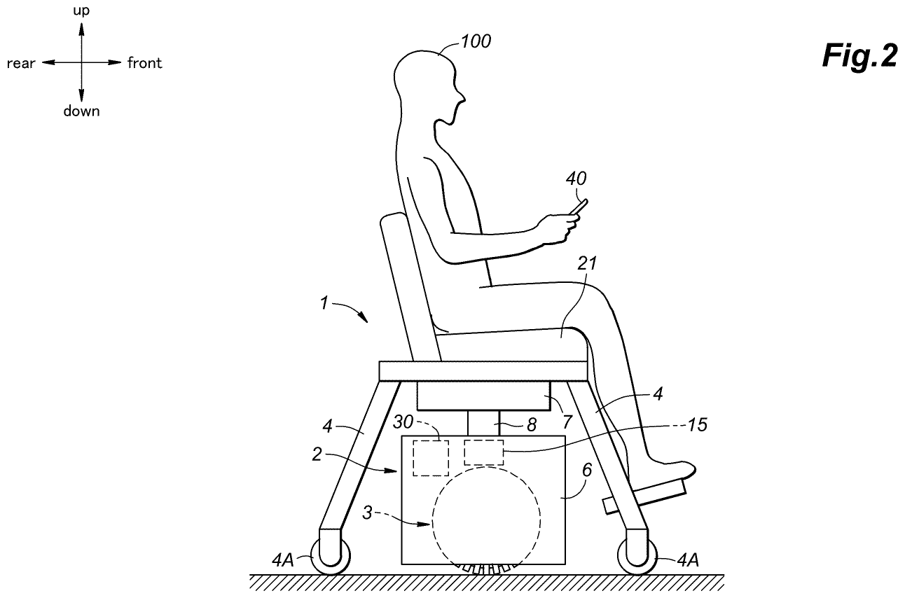

As shown in FIG. 1 and FIG. 2, the lift device 8 raises and lowers the main body upper portion 7 between a low position and a high position. The lift device 8 includes a lower member 8A tiltably provided on the main body lower portion 6 and an upper member 8B supported to be movable up and down relative to the lower member 8A and joined to the main body upper portion 7. Each of the lower member 8A and the upper member 8B is preferably formed in a tubular shape extending in the up-down direction, for example. The lower member 8A is slidably inserted into an inside of the upper member 8B. Inside the upper member 8B and the lower member 8A, an expansion and contraction mechanism for moving the upper member 8B relative to the lower member 8A is provided. The expansion and contraction mechanism is preferably a screw mechanism, for example. The screw mechanism preferably includes a screw shaft extending vertically and rotatably supported by the upper member 8B, an electric motor 15 provided on the upper end of the upper member 8B to rotate the screw shaft, and a nut provided on the lower member 8A and threadedly engaged with the screw shaft. When the screw shaft is rotated by the electric motor 15, the upper member 8B moves upward or downward relative to the lower member 8A. Namely, the lift device 8 expands or contracts in the up-down direction. The expansion and contraction mechanism may be a rack-and-pinion mechanism, a linear motor, or an air cylinder that expands and contracts with compressed air. Inside the upper member 8B and the lower member 8A, a spring for urging the lower member 8A and the upper member 8B toward each other and a damper for damping the movement of the upper member 8B relative to the lower member 8A may be further provided. The damper is preferably a cylinder damper.

The lower member 8A is provided on the main body lower portion 6 to be tiltable about tilt shaft 19 extending in the front-rear direction (X-axis direction). The lower member 8A is provided on the main body lower portion 6 to be tiltable about the tilt shaft 19 extending in the front-rear direction. Preferably, the lower member 8A is pivotably supported on the tilt shaft 19 provided in the main body lower portion 6 to extend in the front-rear direction.

As shown in FIG. 1 to FIG. 3, the main body upper portion 7 includes a seat 21 on which the occupant 100 is to be seated. The seat 21 is preferably provided on an upper part of the main body upper portion 7.

The multiple legs 4 have the same configuration. The legs 4 extend downward from the main body upper portion 7. Each leg 4 is displaceable between a ground contact position in which the leg 4 contacts the floor surface and a retracted position in which the leg 4 is separated upward from the floor surface. In the present embodiment, the main body upper portion 7 to which the legs 4 are joined is raised and lowered by the lift device 8, whereby the legs 4 are displaced between the ground contact position and the retracted position. Namely, the lift device 8 raises and lowers the legs 4 between the ground contact position and the retracted position. In another embodiment, another lift device for raising and lowering the legs 4 between the ground contact position and the retracted position may be provided between the main body upper portion 7 and each leg 4. In the present embodiment, the legs 4 are in the ground contact position when the main body upper portion 7 is in the low position, and the legs 4 are in the retracted position when the main body upper portion 7 is in the high position.

Each leg 4 has a turning caster 4A at the lower end thereof. When the leg 4 is in the ground contact position, the leg 4 contacts the ground (floor surface) at the turning caster 4A. In a state in which each leg 4 contacts the ground, the main body 2 is maintained in an upright posture. The legs 4 maintain the main body 2 in the upright posture by contacting the ground.

As shown in FIG. 1 and FIG. 5, the mobile body 1 includes a control device 30 for controlling the pair of omnidirectional wheels 3 and the lift device 8. The control device 30 is a computer including a processor and a memory communicatively connected to the processor. The processor preferably includes, as a core, at least one of a CPU (Central processing Unit), a GPU (Graphics Processing Unit), and a RISC (Reduced Instruction Set Computer), for example. The memory stores a control program executed by the processor and various data. The processor implements various applications by executing the program stored in the memory. The control device 30 is preferably provided in the main body lower portion 6 or the main body upper portion 7.

The mobile body 1 includes multiple operation state sensors 31 provided for the respective electric motors 15 of the left and right omnidirectional wheels 3 to detect the operation state of each electric motor 15, a tilt sensor 32 for detecting the tilt angle of the main body 2, a yaw rate sensor 33 for detecting the yaw rate of the main body 2, and a position sensor 34 for detecting the height of the main body upper portion 7 relative to the main body lower portion 6. The multiple operation state sensors 31, the tilt sensor 32, the yaw rate sensor 33, and the position sensor 34 are connected to the control device 30.

The operation state sensor 31 corresponding to each electric motor 15 includes, for example, a current sensor for detecting the energizing current of the electric motor 15, and a rotation sensor for detecting the rotation angle or the rotation speed (the angular velocity) of the output shaft of the electric motor 15. In this case, the rotation sensor may be configured by, for example, a resolver, a rotary encoder, a potentiometer, or the like.

The tilt sensor 32 is preferably configured by, for example, a known inertial measurement unit (IMU) capable of detecting the three-axis (three-dimensional) acceleration and the three-axis (three-dimensional) angular velocity. The tilt sensor 32 is preferably mounted on the main body upper portion 7. The tilt sensor 32 executes a known measurement calculation process such as a strap-down method based on the detected acceleration and angular velocity, and thereby measures the tilt angle of the main body upper portion 7 in the roll direction (the direction around the X-axis) and the pitch direction (the direction around the Y-axis), and outputs the measurement data. Note that the measurement calculation process may be executed by the control device 30.

The yaw rate sensor 33 is configured by a known angular velocity sensor and detects the yaw rate generated during the turning operation of the mobile body 1. The yaw rate sensor 33 is preferably provided on the main body lower portion 6, for example. In the case where the tilt sensor 32 is configured by an inertial measurement unit, the tilt sensor 32 may also measure the yaw rate based on the detection data of the acceleration and the angular velocity by a measurement calculation process such as the strap-down method. Namely, the tilt sensor 32 may function as the yaw rate sensor 33.

The control device 30 performs wireless communication or wired communication with an operation terminal 40 held by the occupant 100 or the like. The operation terminal 40 is preferably a smartphone, a tablet terminal, or the like, for example. The operation terminal 40 can perform a maneuver operation of the mobile body 1 by activating a pre-installed maneuver application.

The operation terminal 40 may be a remote control type operation terminal including an operation part for the maneuver operation of the mobile body 1 such as a joystick. Also, the operation terminal 40 may be mounted on the main body upper portion 7.

The control device 30 includes an inverted pendulum control part 51, a lift control part 52, and an abnormality monitoring part 53 as functions realized by both or one of an implemented hardware configuration and a program (a software configuration).

The lift control part 52 controls the lift device 8 to raise and lower the main body upper portion 7 and the seat 21 between the low position and the high position. The lift control part 52 controls the electric motor 15 of the lift device 8 based on raise/lower signals from the operation terminal 40. Preferably, the operation terminal 40 displays raise/lower buttons on an operation screen, and when the raise/lower buttons are operated by the occupant 100, transmits the raise/lower signals to the control device 30.

The inverted pendulum control part 51 performs inverted pendulum control in a state in which the main body upper portion 7 has been raised from the low position, namely, in a state in which each leg 4 is separated from the floor surface. The inverted pendulum control part 51 includes a target translational speed determination part 56, a target turning speed determination part 57, an individual target translational speed determination part 58, and an abnormal time target speed determination part 59. The target translational speed determination part 56 sequentially determines a target translational speed, which is a target value of the translational speed of the mobile body 1. The target translational speed includes a target front-rear translational speed and a target lateral translational speed. The target turning speed determination part 57 sequentially determines a target turning speed, which is a target value of the angular velocity (the yaw rate) of the mobile body 1 in the yaw direction. The individual target translational speed determination part 58 determines the target translational speed of each of the omnidirectional wheels 3.

In the inverted pendulum control, the inverted pendulum control part 51 controls the electric motors 15 of the left and right omnidirectional wheels 3 so as to balance the overall center of gravity including the mobile body 1 and the occupant 100 like the mass point of the inverted pendulum. Balancing the overall center of gravity of the mobile body 1 means that the resultant force of the gravity acting on the overall center of gravity and the inertial force generated by the movement of the overall center of gravity is balanced with the floor reaction force received by the mobile body 1 from the floor surface. Also, the inverted pendulum control part 51 controls the electric motors 15 of the left and right omnidirectional wheels 3 to make the mobile body 1 travel in accordance with the operation of the operation terminal 40 by the occupant 100.

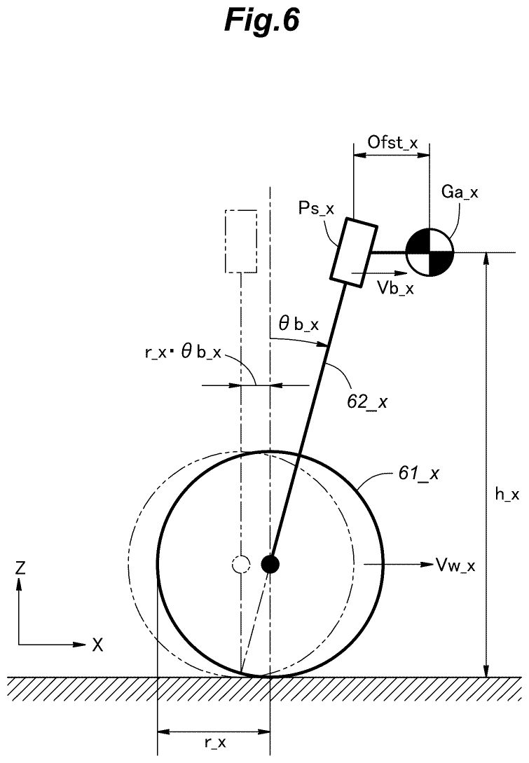

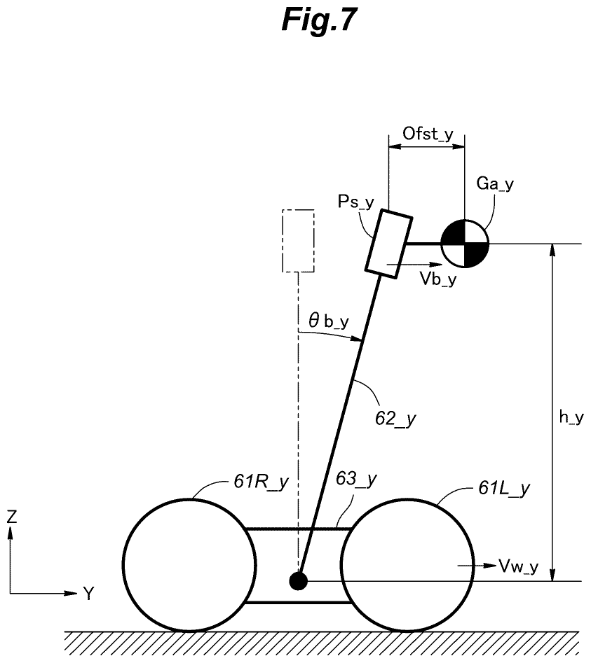

As shown in FIG. 6 and FIG. 7, the kinetic behavior of the overall center of gravity of the mobile body 1 is represented by the behavior of the inverted pendulum models. The subscript “x” represents a component in the X-axis direction, and the subscript “y” represents a component in the Y-axis direction. As shown in FIG. 6, the inverted pendulum model representing the behavior of the overall center of gravity of the mobile body 1 viewed from the Y-axis direction includes a wheel 61_x, which has a rotation axis parallel to the Y-axis direction and is rollable on the floor surface in the X-axis direction; a rod 62_x which extends from the rotation center of the wheel 61_x and is swingable around the rotation axis of the wheel 61_x (in the pitch direction); and a mass point Ga_x connected to a reference part Ps_x, which is the tip end (the upper end) of the rod 62_x.

The wheel 61_x is a wheel that models and represents the left and right omnidirectional wheels 3 which roll in the X-axis direction. The radius r_x of the wheel 61_x is set to a value that matches the radius of the omnidirectional wheels 3 viewed from the axial direction of the cores 11A of the omnidirectional wheels 3. Further, the height h_x of the reference part Ps_x and the mass point Ga_x from the floor surface is set to a preset default value (constant value).

In this inverted pendulum model, the movement of the mass point Ga_x corresponds to the movement of the overall center of gravity of the mobile body 1 viewed from the Y-axis direction, and the tilt angle θb_x of the rod 62_x with respect to the vertical direction matches the tilt angle of the main body upper portion 7 in the pitch direction. Further, the X-axis direction translational movement of the omnidirectional wheels 3 corresponds to the X-axis direction translational movement of the wheel 61_x due to rolling.

As shown in FIG. 7, the inverted pendulum model representing the behavior of the overall center of gravity of the mobile body 1 viewed from the X-axis direction includes a pair of left and right wheels 61L_y and 61R_y which have rotation axes parallel to the X-axis direction and are rollable on the floor surface in the Y-axis direction; a connection part 63_y which connects the wheels 61L_y and 61R_y; a rod 62_y which extends from the connection part 63_y; and a mass point Ga_y connected to a reference part Ps_y, which is the tip end (the upper end) of the rod 62y.

The rod 62_y is axially supported by the connection part 63_y to be swingable in the roll direction around the X-axis-direction axis at an intermediate position between the wheels 61L_y and 61R_y. The wheels 61L_y and 61R_y are wheels that respectively model and represent the omnidirectional wheels 3 which move in the Y-axis direction. Further, the height h_y of the reference part Ps_y and the mass point Ga_y from the swing fulcrum of the rod 62_y is set to a preset default value (constant value).

In this inverted pendulum model, the movement of the mass point Ga_y corresponds to the movement of the overall center of gravity of the mobile body 1 viewed from the X-axis direction, and the tilt angle θb_y of the rod 62_y with respect to the vertical direction matches the tilt angle of the main body upper portion 7 in the roll direction. Further, the Y-axis direction translational movement of the omnidirectional wheels 3 corresponds to the Y-axis direction translational movement of the wheels 61R_y and 61L_y due to rolling.

In FIG. 6, the position of the reference part Ps_x corresponds to the position of the overall center of gravity of the mobile body 1 in the case where it is assumed that the occupant 100 riding on the main body upper portion 7 remains still in a predetermined neutral posture with respect to the main body upper portion 7. Therefore, in the case where the occupant 100 remains still in the neutral posture with respect to the main body upper portion 7, the position of the mass point Ga_x matches the position of the reference part Ps_x. This also applies to the positional relationship between the reference part Ps_y and the mass point Ga_y when viewed from the X-axis direction.

However, when the occupant 100 riding on the main body upper portion 7 moves with respect to the main body upper portion 7, the X-axis direction position and Y-axis direction position of the overall center of gravity generally deviate in the horizontal direction from the positions of the reference parts Ps_x and Ps_y, respectively. Therefore, in FIG. 6 and FIG. 7, the positions of the mass points Ga_x and Ga_y are shown in a state of being deviated from the positions of the reference parts Ps_x and Ps_y, respectively.

The behavior of the overall center of gravity of the mobile body 1 represented by the inverted pendulum models as described above is expressed by the following equations (1A), (1B), (2A), and (2B). The equations (1A) and (1B) represent the behavior viewed in the Y-axis direction, and the equations (2A) and (2B) represent the behavior viewed in the X-axis direction.

Vb_x=Vw_x+h_x·ωb_x (1A)

dVb_x/dt=(g/h_x)·(θb_x·(h_x−r_x)+Ofst_x)+ωz·Vb_y (1B)

Vb_y=Vw_y+h_y·ωb_y (2A)

dVb_y/dt=(g/h_y)·(θb_y·h_y+Ofst_y)−ωz·Vb_x (2B)

Here, Vb_x is the X-axis direction translational speed of the overall center of gravity of the mobile body 1; θb_x is the tilt angle of the main body upper portion 7 in the direction around the Y-axis (the pitch direction); Vw_x is the X-axis direction translational speed of the wheel 61_x; ωb_x is the angular velocity representing the temporal change rate of θb_x (=dθb_x/dt); Ofst_x is the X-axis direction offset amount of the X-axis direction position of the overall center of gravity of the mobile body 1 (the X-axis direction position of the mass point Ga_x) from the position of the reference part Ps_x; Vb_y is the Y-axis direction translational speed of the overall center of gravity of the mobile body 1; Vw_y is the Y-axis direction translational speed of the wheels 61L_y and 61R_y; θb_y is the tilt angle of the main body upper portion 7 in the direction around the X-axis (the roll direction); ωb_y is the angular velocity representing the temporal change rate of θb_y (=dθb_y/dt); and Ofst_y is the Y-axis direction offset amount of the Y-axis direction position of the overall center of gravity of the mobile body 1 (the Y-axis direction position of the mass point Ga_y) from the position of the reference part Ps_y. Further, ωz is the turning speed (the angular velocity in the yaw direction) of the mobile body 1, and g is the gravitational acceleration constant.

Further, in the equations (1A), (1B), (2A), and (2B), the positive direction of θb_x and ωb_x is the direction in which the overall center of gravity of the mobile body 1 is tilted in the positive direction of the X-axis (forward), and the positive direction of θb_y and ωb_y is the direction in which the overall center of gravity of the mobile body 1 is tilted in the positive direction of the Y-axis (leftward). Further, the positive direction of ωz is the counterclockwise direction when the mobile body 1 is viewed from above.

In the embodiment, the algorithm of the process of the inverted pendulum control part 51 is constructed based on the inverted pendulum models that consider the offset amounts of the overall center of gravity of the mobile body 1 from the reference parts Ps_x and Ps_y (hereinafter referred to as the center of gravity offset amount) and the centrifugal force. In the following description, regarding reference numerals of state quantities such as the speed and the acceleration, a reference numeral to which the subscript “xy” is added means a set of an X-axis direction component and a Y-axis direction component.

The inverted pendulum control part 51 sequentially executes the process of the target translational speed determination part 56, the process of the target turning speed determination part 57, and the process of the individual target translational speed determination part 58 in a predetermined calculation process cycle, and performs the inverted pendulum control of the omnidirectional wheels 3.

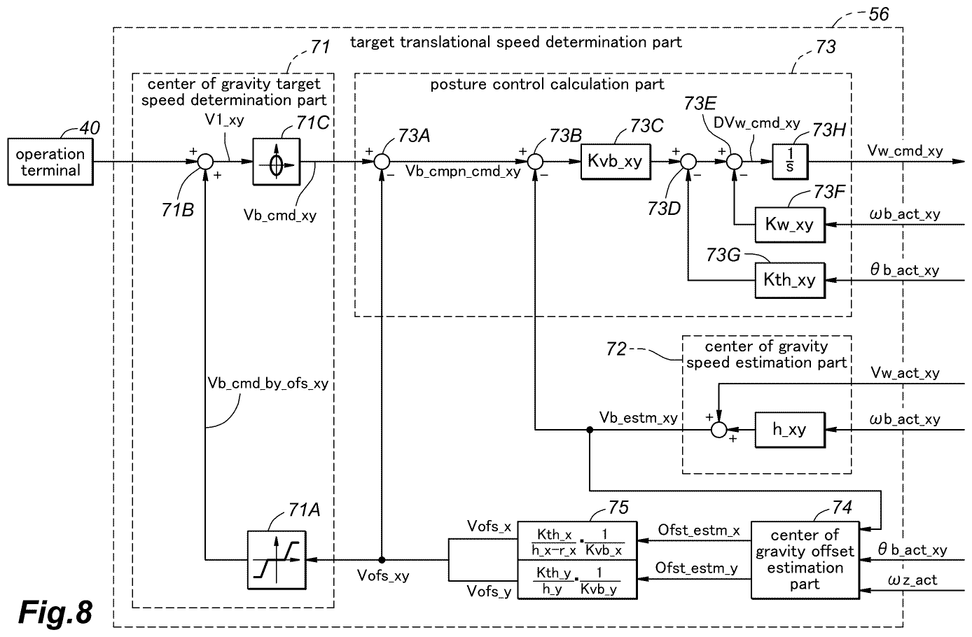

As shown in FIG. 8, the target translational speed determination part 56 includes a center of gravity target speed determination part 71 for determining the center of gravity target speed, which is a target value of the translational speed of the overall center of gravity of the mobile body 1; a center of gravity speed estimation part 72 for estimating the center of gravity speed, which is the actual translational speed of the overall center of gravity of the mobile body 1; a posture control calculation part 73 for determining the overall target translational speed of the omnidirectional wheels 3 to stabilize the posture of the main body upper portion 7 while making the actual center of gravity speed follow the center of gravity target speed; a center of gravity offset estimation part 74 for estimating the center of gravity offset amount (which will be described later) of the overall center of gravity of the mobile body 1; and a center of gravity offset influence amount calculation part 75 for calculating the center of gravity offset influence amount (which will be described later) due to the center of gravity offset amount.

The target translational speed determination part 56 first executes the process of the center of gravity speed estimation part 72 in each calculation process cycle. The center of gravity speed estimation part 72 calculates a first center of gravity speed estimation value Vb_estm_xy, which is an estimation value of the actual center of gravity speed of the mobile body 1, based on the kinematic relational expressions represented by the equations (1A) and (2A). Specifically, as shown in FIG. 8, the first center of gravity speed estimation value Vb_estm_xy is calculated by the following equations (3A) and (3B) based on the value of the actual translational speed Vw_act_xy of the omnidirectional wheels 3, the actual temporal change rate (the tilt angular velocity) ωb_act_xy of the tilt angle θb_xy of the main body upper portion 7, and the height h_xy (default set value) of the overall center of gravity.

Vb_estm_x=Vw_act_x+h_x·ωb_act_x (3A)

Vb_estm_y=Vw_act_y+h_y·ωb_act_y (3B)

In the equations (3A) and (3B), the overall target translational speed Vw_cmd_xy (the previous value) of the omnidirectional wheels 3 determined by the posture control calculation part 73 in the previous calculation process cycle is used as Vw_act_x and Vw_act_y. In another embodiment, for example, the rotation speed of each output shaft of the electric motors 15LL, 15LR, 15RL, and 15RR may be detected, and the latest values of Vw_act_x and Vw_act_y estimated from those detection values may be used.

In the equations (3A) and (3B), the latest values of the temporal change rates of the measurement values of the tilt angles θb_x and θb_y of the main body upper portion 7 measured by the tilt sensor 32 or the latest values of the measurement values of ωb_act_x and ωb_act_y are used as ωb_act_x and ωb_act_y.

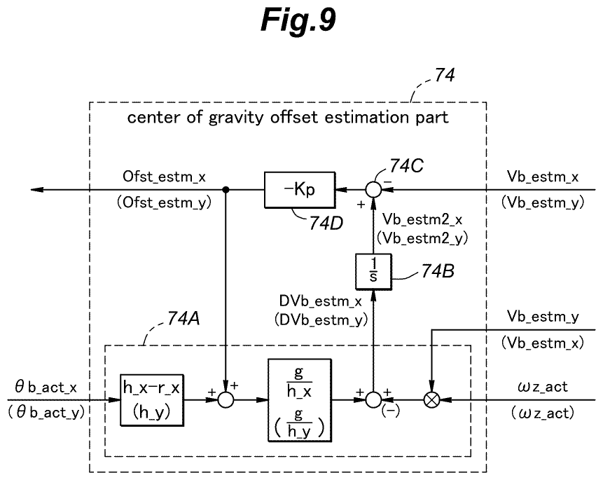

Next, the target translational speed determination part 56 determines the center of gravity offset amount estimation value Ofst_estm_xy, which is an estimation value of the center of gravity offset amount Ofst_xy, by executing the process of the center of gravity offset estimation part 74. The process of the center of gravity offset estimation part 74 is executed, for example, as shown in the block diagram of FIG. 9. In FIG. 9, among the center of gravity offset amount estimation value Ofst_estm_xy, the reference numeral of the state quantity related to the determination process of the X-axis direction center of gravity offset amount estimation value Ofst_estm_x is shown without parentheses, and the reference numeral of the state quantity related to the determination process of the Y-axis direction center of gravity offset amount estimation value Ofst_estm_y is shown in parentheses. Further, for the arithmetic symbols (“+” and “−”), the arithmetic symbols common to both the determination process of the X-axis direction center of gravity offset amount estimation value Ofst_estm_x and the determination process of the Y-axis direction center of gravity offset amount estimation value Ofst_estm_y are shown by symbols without parentheses, and arithmetic symbols related only to the determination process of the Y-axis direction center of gravity offset amount estimation value Ofst_estm_y are shown by symbols with parentheses.

As shown in FIG. 9, the center of gravity offset estimation part 74 uses a measurement value (the latest value) of the tilt angle θb_act_xy measured by the tilt sensor 32, a measurement value (the latest value) of the yaw rate ωz_act measured by the yaw rate sensor 33, the first center of gravity speed estimation value Vb_estm_xy (the latest value) calculated by the center of gravity speed estimation part 72, and the center of gravity offset amount estimation value Ofst_estm_xy (the previous value) determined in the previous calculation process cycle to execute the calculation process on the right side of the equations (1B) and (2B) by a calculation part 74A, thereby calculating the estimation value DVb_estm_xy of the translational acceleration of the overall center of gravity of the mobile body 1.

Further, a calculation part 74B of the center of gravity offset estimation part 74 executes a process of integrating each component (the X-axis direction component and the Y-axis direction component) of the translational acceleration estimation value DVb_estm_xy by, and thereby calculates a second center of gravity speed estimation value Vb_estm2_xy, which is a second estimation value of the overall center of gravity speed of the mobile body 1.

Next, a calculation part 74C of the center of gravity offset estimation part 74 executes a process of calculating the difference of each component between the second center of gravity speed estimation value Vb_estm2_xy (the latest value) and the first center of gravity speed estimation value Vb_estm_xy (the latest value). Further, a calculation part 74D of the center of gravity offset estimation part 74 executes a process of multiplying each component of the difference by a gain (−Kp) having a predetermined value, and thereby determines the latest value of the center of gravity offset amount estimation value Ofst_estm_xy.

Next, the target translational speed determination part 56 executes the process of the center of gravity offset influence amount calculation part 75 shown in FIG. 8, and thereby calculates the center of gravity offset influence amount Vofs_xy. The center of gravity offset influence amount Vofs_xy represents the offset of the actual speed with respect to the target speed of the overall center of gravity when feedback control is performed without considering that the position of the overall center of gravity of the mobile body 1 deviates from the position of the reference part Ps_xy in the inverted pendulum model in the posture control calculation part 73 (to be described later).

The center of gravity offset influence amount calculation part 75 multiplies the newly determined X-axis direction center of gravity offset amount estimation value Ofst_estm_x by a value (Kth_x/(h_x−r_x))/Kvb_x, and thereby calculates the X-axis direction center of gravity offset influence amount Vofs_xy. Further, the center of gravity offset influence amount calculation part 75 multiplies the newly determined Y-axis direction center of gravity offset amount estimation value Ofst_estm_y by a value (Kth_y/h_y)/Kvb_y, and thereby calculates the Y-axis direction center of gravity offset influence amount Vofs_y. Note that Kth_x, Kth_y, Kvb_x, and Kvb_y are gains of predetermined values used in the process of the posture control calculation part 73, which will be described later.

Next, the target translational speed determination part 56 executes the process of the center of gravity target speed determination part 71 shown in FIG. 8, and thereby determines the center of gravity target speed Vb_cmd_xy for each calculation process cycle. The center of gravity target speed determination part 71 first determines a basic value V1_xy of the center of gravity target speed Vb_cmd_xy, based on the speed command Vs_xy (the latest value) given by the operation terminal 40 according to the operation of the operation terminal 40 and based on the center of gravity offset influence amount Vofs_xy (the latest value) determined by the center of gravity offset influence amount calculation part 75. The basic value V1_xy corresponds to a request value of the center of gravity speed according to the operation of the operation terminal 40 and the center of gravity offset amount estimation value Ofst_estm_xy due to the movement of the occupant 100. Hereinafter, the above basic value V1_xy will be referred to as a center of gravity speed basic request value V1_xy.

A calculation part 71A of the center of gravity target speed determination part 71 executes a dead zone process and a limit process for the center of gravity offset influence amount Vofs_xy by, and thereby determines a target center of gravity speed addition amount Vb_cmd_by_ofs_xy as a component corresponding to the center of gravity offset amount estimation value Ofst_estm_xy in the center of gravity speed basic request value V1_xy.

The center of gravity target speed determination part 71 sets the X-axis direction target center of gravity speed addition amount Vb_cmd_by_ofs_x to zero when the magnitude of the X-axis direction center of gravity offset influence amount Vofs_x is within the dead zone, which is a predetermined range near zero.

When the magnitude of the X-axis direction center of gravity offset influence amount Vofs_x is a value deviating from the dead zone, the center of gravity target speed determination part 71 determines the X-axis direction target center of gravity speed addition amount Vb_cmd_by_ofs_x such that the X-axis direction target center of gravity speed addition amount Vb_cmd_by_ofs_x has the same polarity as Vofs_x, and its magnitude (the absolute value) increases as the magnitude of the deviation amount of Vofs_x from the dead zone increases. However, the value of the target center of gravity speed addition amount Vb_cmd_by_ofs_x is limited to a range between a predetermined upper limit value (>0) and a predetermined lower limit value (≤0). The determination process of the Y-axis direction target center of gravity speed addition amount Vb_cmd_by_ofs_y is the same as that described above.

A calculation part 71B of the center of gravity target speed determination part 71 executes a process of adding each component of the target center of gravity speed addition amount Vb_cmd_by_ofs_xy to each component of the speed command Vs_xy given from the operation terminal 40, and thereby calculates the center of gravity speed basic request value V1_xy. That is, the center of gravity speed basic request value V1_xy (a set of V1_x and V1_y) is determined by the calculation process of V1_x=Vs_x+Vb_cmd_by_ofs_x and V1_y=Vs_y+Vb_cmd_by_ofs_y.

A calculation part 71C of the center of gravity target speed determination part 71 executes a limit process of determining the center of gravity target speed Vb_cmd_xy (a set of Vb_cmd_x and Vb_cmd_y) by limiting the set of the center of gravity speed basic request values V1_x and V1_y, in order to limit the rotation speed of each output shaft of the electric motors 15 for driving each omnidirectional wheel 3 within a predetermined allowable range. When the set of the center of gravity speed basic request values V1_x and V1_y obtained by the calculation part 71B is within a predetermined region in a coordinate system with the value of V1_x as the vertical axis and the value of V1_y as the horizontal axis, the set of the center of gravity speed basic request values V1_x and V1_y is determined as the center of gravity target speed Vb_cmd_xy as it is. On the other hand, when the set of the center of gravity speed basic request values V1_x and V1_y obtained by the calculation part 71B deviates from the predetermined region in the coordinate system, the set is limited to a set on the boundary of the predetermined region and the set on the boundary of the predetermined region is determined as the center of gravity target speed Vb_cmd_xy.

The center of gravity target speed Vb_cmd_xy is determined according to the speed command Vs_xy according to the operation of the operation terminal 40 and the center of gravity offset influence amount Vofs_xy (or the center of gravity offset amount Ofst_xy). Therefore, each of the operation of the operation terminal 40 and the change in the center of gravity offset amount Ofst_xy due to the movement (weight movement) of the upper body and the like of the occupant 100 functions as the maneuver operation related to the movement of the mobile body 1. The speed command Vs_xy by the operation of the operation terminal 40 may be omitted, and the target center of gravity speed addition amount Vb_cmd_by_ofs_xy may be determined as it is as the center of gravity speed basic request value V1_xy. Alternatively, the speed command Vs_xy by the operation of the operation terminal 40 may be determined as it is as the center of gravity speed basic request value V1_xy.

The posture control calculation part 73 determines the overall target translational speed Vw_cmd_xy of the omnidirectional wheels 3 to stabilize the posture of the main body upper portion 7 by the process shown in the block diagram of FIG. 8.

A calculation part 73A of the posture control calculation part 73 executes a process of subtracting each component of the center of gravity offset influence amount Vofs_xy from each component of the center of gravity target speed Vb_cmd_xy, and thereby determines the target speed Vb_cmpn_cmd_xy after compensation for the center of gravity offset.

Next, the calculation parts 73B, 73C, 73D, 73E, 73F, and 73G of the posture control calculation part 73 calculate the X-axis direction target translational acceleration DVw_cmd_x and the Y-axis direction target translational acceleration DVw_cmd_y in the target translational acceleration DVw_cmd_xy, which is a target value of the overall translational acceleration of the omnidirectional wheels 3, based on the following equations (4A) and (4B).

DVw_cmd_x=Kvb_x·(Vb_cmpn_cmd_x−Vb_estm_x)−Kth_x·θb_act_x−Kw_x·ωb_act_x (4A)

DVw_cmd_y=Kvb_y·(Vb_cmpn_cmd_y−Vb_estm_y)−Kth_y·θb_act_y−Kw_y·ωb_act_y (4B)

Here, Kvb_xy, Kth_xy, and Kw_xy are gains of predetermined values set in advance. On the right side of the equation (4A), the first term is a feedback operation amount component according to the difference between the X-axis direction target speed Vb_cmpn_cmd_x (the latest value) after compensation for the center of gravity offset of the overall center of gravity of the mobile body 1 and the X-axis direction center of gravity speed estimation value Vb_estm_x (the latest value) calculated by the center of gravity speed estimation part 72. The second term is a feedback operation amount component according to the measurement value (the latest value) of the actual tilt angle θb_act_x of the main body upper portion 7 in the pitch direction (the direction around the Y-axis). The third term is a feedback operation amount component according to the measurement value (the latest value) of the actual tilt angular velocity ωb_act_x of the main body upper portion 7 in the pitch direction. The X-axis direction target translational acceleration DVw1_cmd_x is calculated as a combined operation amount of these feedback operation amount components.

Similarly, on the right side of the equation (4B), the first term is a feedback operation amount component according to the difference between the Y-axis direction target speed Vb_cmpn_cmd_y (the latest value) after compensation for the center of gravity offset of the overall center of gravity of the mobile body 1 and the Y-axis direction center of gravity speed estimation value Vb_estm_y (the latest value) calculated by the center of gravity speed estimation part 72. The second term is a feedback operation amount component according to the measurement value (the latest value) of the actual tilt angle θb_act_y of the main body upper portion 7 in the roll direction (the direction around the X-axis). The third term is a feedback operation amount component according to the measurement value (the latest value) of the actual tilt angular velocity ωb_act_y of the main body upper portion 7 in the roll direction. The Y-axis direction target translational acceleration DVw1_cmd_y is calculated as a combined operation amount of these feedback operation amount components.

The equations (4A) and (4B) may be rewritten into the following equations (4A)′ and (4B)′, respectively.

DVw_cmd_x=Kvb_x·(Vb_cmd_x−Vb_estm_x)−Kth_x·(Ofst_estm_x/(h_x−r_x)+θb_act_x)−Kw_x·ωb_act_x (4A)′

DVw_cmd_y=Kvb_y·(Vb_cmd_y−Vb_estm_y)−Kth_y·(Ofst_estm_y/h_y+θb_act_y)−Kw_y·ωb_act_y (4B)′

When the mobile body 1 is viewed from the Y-axis direction, the second term on the right side of the equation (4A)′ has a meaning as a feedback operation amount component for making the actual position of the overall center of gravity of the mobile body 1 in the X-axis direction be a position directly above the floor-contacting part of the omnidirectional wheels 3.

Further, when the mobile body 1 is viewed from the X-axis direction, the second term on the right side of the equation (4B)′ has a meaning as a feedback operation amount component for making the actual position of the overall center of gravity of the mobile body 1 in the Y-axis direction be a position directly above the tilt shaft 19 of the main body upper portion 7.

A calculation part 73H of the posture control calculation part 73 determines the overall target translational speed Vw_cmd_xy (the latest value) of the omnidirectional wheels 3 by integrating each component of the target translational acceleration DVw_cmd_xy.

By the target translational speed determination part 56, the overall target translational speed Vw_cmd_xy of the omnidirectional wheels 3 is sequentially determined so that the actual center of gravity speed of the mobile body 1 can be made to follow the center of gravity target speed Vb_cmd_xy while maintaining the stable posture of the main body upper portion 7 of the mobile body 1.

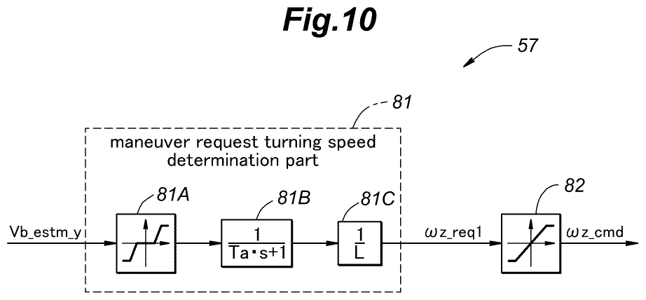

As shown in FIG. 10, the target turning speed determination part 57 executes a process of a maneuver request turning speed determination part 81 for determining a maneuver request turning speed ωz_req, which is a request value of the turning speed of the mobile body 1 based on the maneuver operation of the occupant 100 of the mobile body 1. Regarding the process of the maneuver request turning speed determination part 81, in the embodiment, the action of the occupant 100 moving the upper body or the like so as to move the overall center of gravity of the mobile body 1 in the Y-axis direction is a maneuver operation for performing the turning action of the mobile body 1.

For example, when trying to turn the mobile body 1 to the right side (the clockwise direction when viewed from above), the occupant 100 performs a weight transfer operation such as tilting the upper body to the right side, and thereby moves the overall center of gravity of the mobile body 1 to the right side. Further, when trying to turn the mobile body 1 to the left side (the counterclockwise direction when viewed from above), the occupant 100 performs a weight transfer operation such as tilting the upper body to the left side, and thereby moves the overall center of gravity of the mobile body 1 to the left side.

In the embodiment, in the process of the maneuver request turning speed determination part 81, the Y-axis direction center of gravity speed estimation value Vb_estm_y calculated by the center of gravity speed estimation part 72 is regarded as an index value representing a maneuver operation for turning the mobile body 1. The maneuver request turning speed ωz_req is determined according to the Y-axis direction center of gravity speed estimation value Vb_estm_y (the latest value) of the maneuver request turning speed determination part 81.

A calculation part 81a of the maneuver request turning speed determination part 81 executes a dead zone process on the input Y-axis direction center of gravity speed estimation value Vb_estm_y. In the dead zone process, the calculation part 81A sets the output value of the calculation part 81A to zero when the Y-axis direction center of gravity speed estimation value Vb_estm_y is a value within a predetermined dead zone near zero.

When the Y-axis direction center of gravity speed estimation value Vb_estm_y is a value deviating from the dead zone, the calculation part 81A determines the output value of the calculation part 81A such that the output value of the calculation part 81A has the same polarity as Vb_estm_y, and its magnitude (the absolute value) increases as the magnitude of the deviation amount of Vb_estm_y from the dead zone increases. For example, when Vb_estm_y is greater than the upper limit value (>0) of the dead zone, the output value of the calculation part 81A is determined to be a value proportional to (Vb_estm_y−the upper limit value of the dead zone), and when Vb_estm_y is less than the lower limit value (<0) of the dead zone, the output value of the calculation part 81A is determined to be a value proportional to (Vb_estm_y−the lower limit value of the dead zone).

A calculation part 81B of the maneuver request turning speed determination part 81 executes a low-pass characteristic filtering process on the output value of the calculation part 81A. For example, the calculation part 81B may use a low-pass filter represented by a transfer function of 1/(Ta·s+1), where Ta is a time constant.

A calculation part 81C of the maneuver request turning speed determination part 81 executes a process of dividing the output value of the calculation part 81B by a preset turning radius L having a predetermined value, and thereby determines the maneuver request turning speed ωz_req. In this way, the maneuver request turning speed ωz_req based on the maneuver operation of the occupant 100 is determined.

The turning speed may be set by an operation of the operation terminal 40. In this case, the turning speed set by the operation terminal 40 may be set as the maneuver request turning speed ωz_req. Alternatively, the turning speed obtained by combining the turning speed set by the operation terminal 40 and the turning speed set according to the Y-axis direction center of gravity speed estimation value Vb_estm_y may be set as the maneuver request turning speed ωz_req.

A calculation part 82 of the target turning speed determination part 57 executes a limit process of limiting the maneuver request turning speed ωz_req within a predetermined allowable range, and thereby determines the target turning speed ωz_cmd. In the limit process, when the maneuver request turning speed ωz_req is a value within the predetermined allowable range, the value is determined as the target turning speed ωz_cmd. Further, when the maneuver request turning speed ωz_req is greater than the upper limit value or less than the lower limit value of the predetermined allowable range, the upper limit value and the lower limit value of the allowable range are determined as the target turning speed ωz_cmd, respectively.

After executing the processes of the target translational speed determination part 56 and the target turning speed determination part 57, the inverted pendulum control part 51 executes a process of determining the respective target translational speeds VwL_cmd_xy and VwR_cmd_xy of the omnidirectional wheels 3 by the individual target translational speed determination part 58.

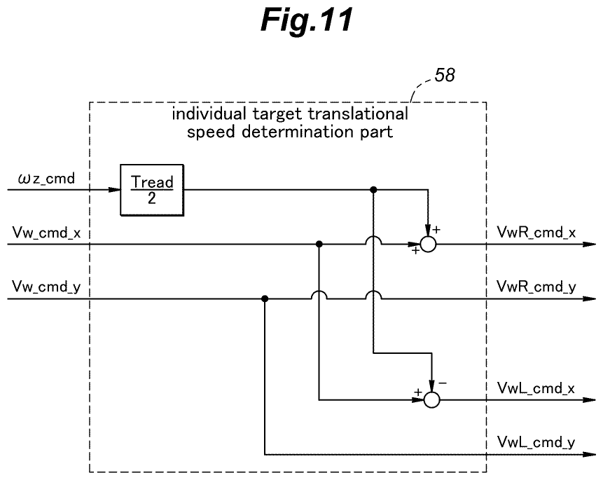

The individual target translational speed determination part 58 determines the respective target translational speeds VwL_cmd_xy and VwR_cmd_xy of the omnidirectional wheels 3 based on the overall target translational speed Vw_cmd_xy of the omnidirectional wheels 3 and the target turning speed ωz_cmd of the mobile body 1 by the process shown in the block diagram of FIG. 11.

The individual target translational speed determination part 58 determines the target translational speed VwL_cmd_xy of the left omnidirectional wheel 3L by the following equations (5A) and (5B), and determines the target translational speed VwR_cmd_xy of the right omnidirectional wheel 3R by the following equations (5C) and (5D).

VwL_cmd_x=Vw_cmd_x−ωz_cmd·(Tread/2) (5A)

VwL_cmd_y=Vw_cmd_y (5B)

VwR_cmd_x=Vw_cmd_x+ωz_cmd·(Tread/2) (5C)

VwR_cmd_y=Vw_cmd_y (5D)

In the above equations (5A) and (5C), Tread is the interval between the omnidirectional wheels 3 in the Y-axis direction. By determining the target translational speeds VwL_cmd_xy and VwR_cmd_xy by the equations (5A) to (5D), the X-axis direction target translational speeds VwL_cmd_x and VwR_cmd_x of the omnidirectional wheels 3 are determined so that the angular velocity in the yaw direction caused by the difference (=VwR_cmd_x−VwL_cmd_x) between the X-axis direction target translational speeds VwL_cmd_x and VwR_cmd_x of the omnidirectional wheels 3 matches the target turning speed ωz_cmd, and the average value of the X-axis direction target translational speeds VwL_cmd_x and VwR_cmd_x of the omnidirectional wheels 3 matches the overall X-axis direction target translational speed Vw_cmd_x of the omnidirectional wheels 3.

Further, the Y-axis direction target translational speeds VwL_cmd_y and VwR_cmd_y of the omnidirectional wheels 3 are determined to be speeds that match the overall Y-axis direction target translational speed Vw_cmd_y of the omnidirectional wheels 3.

The inverted pendulum control part 51 performs the control of the operation of the electric motors 15LL and 15LR of the left omnidirectional wheel 3L according to the target translational speed VwL_cmd_xy from among the target translational speeds VwL_cmd_xy and VwR_cmd_xy, and performs the control of the operation of the electric motors 15RL and 15RR of the right omnidirectional wheel 3R according to the target translational speed VwR_cmd_xy.

The inverted pendulum control part 51 determines, for the left omnidirectional wheel 3L, the target rotation speed of each output shaft of the electric motors 15LL and 15LR corresponding to the target translational speed VwL_cmd_xy based on correlation data (maps, calculation equations and the like) that defines the relationship between the X-axis direction and Y-axis direction translational speeds of the omnidirectional wheel 3L and the rotation speed of each output shaft of the electric motors 15LL and 15LR.

The rotation speed of each output shaft of the electric motors 15LL and 15LR is controlled to the target rotation speed by executing a known speed control for each of the electric motors 15LL and 15LR according to the target rotation speed. In this way, the movement control of the left omnidirectional wheel 3L is performed to realize the target translational speed VwL_cmd_xy. The same applies to the movement control of the right omnidirectional wheel 3R.

As described above, under normal circumstances, the control device 30 calculates target values of the mobile body 1 based on the inverted pendulum control, and controls the pair of omnidirectional wheels 3 based on the target values. In the following, description will be made of the process executed by the control device 30 when an abnormality occurs in the mobile body 1.

The abnormality monitoring part 53 of the control device 30 monitors an abnormality of the mobile body 1. The abnormality of the mobile body 1 indicates a state in which it is impossible to continue the inverted pendulum control. The state in which it is impossible to continue the inverted pendulum control includes, for example, a state in which the offset amount of the overall center of gravity including the mobile body 1 and the occupant 100 from the reference part Ps_x or Ps_y (the center of gravity offset amount) becomes greater than or equal to a predetermined value and the posture of the mobile body 1 cannot be maintained. The abnormality monitoring part 53 preferably determines that an abnormality has occurred when the center of gravity offset amount estimation value Ofst_estm_x is greater than or equal to a predetermined first offset determination value or when the center of gravity offset amount estimation value Ofst_estm_y is greater than or equal to a predetermined second offset determination value.

The state in which it is impossible to continue the inverted pendulum control may include a state in which the value of the target translational speed is greater than or equal to a predetermined speed upper limit, for example. The speed upper limit is preferably set based on an output value that each electric motor 15 can output. When the value of the target translational speed is greater than or equal to the speed upper limit, it is impossible to bring the translational speed closer to the target translational speed, and therefore, the inverted pendulum control cannot be continued. The abnormality monitoring part 53 preferably determines that an abnormality has occurred when the target translational speed Vw_cmd_x is greater than or equal to a predetermined first speed upper limit or when the target translational speed Vw_cmd_y is greater than or equal to a predetermined second speed upper limit.

The state in which it is impossible to continue the inverted pendulum control may include an abnormal state of a sensor provided on the mobile body 1 such as the tilt sensor 32, the yaw rate sensor 33, the operation state sensor 31 of each electric motor 15, or the like. Preferably, the abnormality monitoring part 53 monitors whether the values acquired from the tilt sensor 32, the yaw rate sensor 33, and the operation state sensor 31 of each electric motor 15 belong to respective predetermined abnormal ranges, and determines that an abnormality has occurred when the value from any of these sensors belongs to the abnormal range.

When it is determined that an abnormality has occurred, the abnormality monitoring part 53 outputs an abnormality detection signal to abnormal time control parts of the lift control part 52 and the inverted pendulum control part 51.

When the main body upper portion 7 is in the high position and the abnormality detection signal is received, the lift control part 52 executes emergency descent control to move the main body upper portion 7 from the high position to the low position. In the emergency descent control, the lift control part 52 preferably stops the electric power supply to the electric motor 15 of the lift device 8. Thereby, the main body upper portion 7 descends due to the weight of the main body upper portion 7 and various components mounted to the main body upper portion 7 as well as the weight of the occupant 100. Also, in the emergency descent control, the lift control part 52 may drive the electric motor 15 of the lift device 8 to move the main body upper portion 7 to the low position.

Due to the emergency descent control, the main body upper portion 7 moves from the high position to the low position and each leg 4 contacts the ground. The time required for the main body upper portion 7 to reach the low position from the high position is preferably 0.2 to 1.0 seconds, for example.

When an abnormality is detected, the control device 30 stops calculation of the target values, namely, the target translational speed Vw_cmd_xy and the target turning speed ωz_cmd, and for a predetermined maintenance period from the detection of the abnormality, controls the pair of omnidirectional wheels 3 based on the latest values of the target values calculated immediately before the detection of the abnormality or values obtained by gradually decreasing the latest values. Here, the values obtained by gradually decreasing the latest values means the values obtained by gradually decreasing the latest values toward 0 or changing the latest values to approach 0. Preferably, the values obtained by gradually decreasing the latest values are obtained by multiplying the latest values by a factor greater than 0 and less than 1.

The inverted pendulum control part 51 of the control device 30 stops the inverted pendulum control when the abnormality detection signal is received. Specifically, the target translational speed determination part 56 stops the determination of the target translational speed Vw_cmd_xy, and the target turning speed determination part 57 stops the determination of the target turning speed ωz_cmd. Then, the abnormal time target speed determination part 59 determines the target translational speed Vw_cmd_xy and the target turning speed ωz_cmd.

The abnormal time target speed determination part 59 acquires the latest values of the target translational speed Vw_cmd_xy and the target turning speed ωz_cmd calculated immediately before the detection of the abnormality, namely, immediately before the target translational speed determination part 56 and the target turning speed determination part 57 stop the determination of the target translational speed Vw_cmd_xy and the target turning speed ωz_cmd. The latest values of the target translational speed Vw_cmd_xy and the target turning speed ωz_cmd are referred to as the target translational speed Vw_cmd_xy and the target turning speed ωz_cmd at the time of abnormality occurrence. Then, during the maintenance period, the abnormal time target speed determination part 59 determines the target translational speed Vw_cmd_xy and the target turning speed ωz_cmd based on the latest values of the target translational speed Vw_cmd_xy and the target turning speed ωz_cmd. The target translational speed Vw_cmd_xy and the target turning speed ωz_cmd determined by the abnormal time target speed determination part 59 are referred to as the target translational speed Vw_cmd_xy and the target turning speed ωz_cmd for the maintenance period.

The abnormal time target speed determination part 59 may set the target translational speed Vw_cmd_xy and the target turning speed ωz_cmd at the time of abnormality occurrence as the target translational speed Vw_cmd_xy and the target turning speed ωz_cmd for the maintenance period, and may maintain them during the maintenance period. Also, the abnormal time target speed determination part 59 may set the target translational speed Vw_cmd_xy and the target turning speed ωz_cmd at the time of abnormality occurrence as the initial values of the target translational speed Vw_cmd_xy and the target turning speed ωz_cmd for the maintenance period, and may gradually decrease the absolute values of the target translational speed Vw_cmd_xy and the target turning speed ωz_cmd from the initial values during the maintenance period. In this case, it is preferable that during the maintenance period, the polarities of the values of the target translational speed Vw_cmd_xy and the target turning speed ωz_cmd are maintained. The mode of gradual decrease is preferably linear or stepwise. At the end of the maintenance period, the absolute values of the target translational speed Vw_cmd_xy and the target turning speed ωz_cmd may be 0 or may be greater than 0.

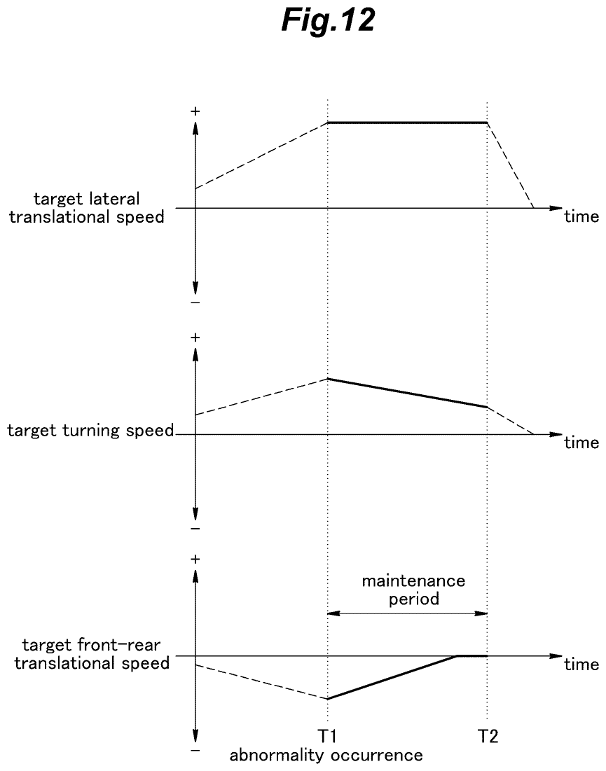

FIG. 12 shows one example of the target translational speed Vw_cmd_xy and the target turning speed ωz_cmd for the maintenance period determined by the abnormal time target speed determination part 59. The abnormal time target speed determination part 59 sets the target lateral translational speed Vw_cmd_y at the time of abnormality occurrence as the initial value of the target lateral translational speed Vw_cmd_y for the maintenance period. Thereafter, the abnormal time target speed determination part 59 maintains the target lateral translational speed Vw_cmd_y for the maintenance period at the initial value during the maintenance period.

The abnormal time target speed determination part 59 sets the target front-rear translational speed Vw_cmd_x at the time of abnormality occurrence as the initial value of the target front-rear translational speed Vw_cmd_x for the maintenance period. Thereafter, the abnormal time target speed determination part 59 gradually decreases the target front-rear translational speed Vw_cmd_x for the maintenance period from the initial value at a predetermined rate during the maintenance period. The target front-rear translational speed Vw_cmd_x reaches 0 before the end (T2) of the maintenance period. After the target front-rear translational speed Vw_cmd_x has reached 0, the abnormal time target speed determination part 59 maintains the target front-rear translational speed Vw_cmd_x at 0.

The abnormal time target speed determination part 59 sets the target turning speed ωz_cmd at the time of abnormality occurrence as the initial value of the target turning speed ωz_cmd for the maintenance period. Thereafter, the abnormal time target speed determination part 59 gradually decreases the target turning speed ωz_cmd for the maintenance period from the initial value at a predetermined rate during the maintenance period. The absolute value of the target turning speed ωz_cmd is set to a value greater than 0 at the end of the maintenance period (T2).

After the end (T2) of the maintenance period, the abnormal time target speed determination part 59 may gradually decrease the target translational speed Vw_cmd_xy and the target turning speed ωz_cmd from the values at the end of the maintenance period. In another embodiment, the abnormal time target speed determination part 59 may set 0 as the target translational speed Vw_cmd_xy and the target turning speed ωz_cmd after the end (T2) of the maintenance period.

The individual target translational speed determination part 58 determines the target translational speeds VwL_cmd_xy and VwR_cmd_xy of the respective omnidirectional wheels 3 based on the target translational speed Vw_cmd_xy and the target turning speed ωz_cmd for the maintenance period. Then, the inverted pendulum control part 51 performs the control of the operation of the electric motors 15LL and 15LR of the left omnidirectional wheel 3L according to the target translational speed VwL_cmd_xy from among the target translational speeds VwL_cmd_xy and VwR_cmd_xy, and performs the control of the operation of the electric motor 15RL and 15RR of the right omnidirectional wheel 3R according to the target translational speed VwR_cmd_xy.

According to the embodiment described above, it is possible to reduce the overturning moment produced when it becomes impossible to continue the inverted pendulum control in the mobile body 1. If the speeds of the omnidirectional wheels 3 are brought to 0, the speed of the lower portion of the mobile body 1 is decelerated while the upper portion of the mobile body 1 and the occupant 100 tend to keep moving due to inertia, and thus, the overturning moment increases. As a result, the time until the mobile body 1 becomes unable to stand on its own becomes short. When the mobile body 1 maintains the speed at the time of abnormality occurrence to some extent, the overturning moment is reduced and the time until the mobile body 1 becomes unable to stand on its own becomes longer. Thereby, it is possible to secure time until each leg 4 of the mobile body 1 comes into contact with the ground. Also, tilting of the main body 2 when each leg 4 comes into contact with the ground can be suppressed.

The embodiment may be modified in various ways without being limited to the above-described configuration. For example, the control device 30 may calculate a target translational acceleration and a target turning acceleration instead of the target translational speed Vw_cmd_xy and the target turning speed ωz_cmd and may control the electric motors 15 based on the target translational acceleration and the target turning acceleration. In this case, when an abnormality occurs, the control device 30 preferably controls the electric motors 15 based on the target translational acceleration and the target turning acceleration at the time of abnormality occurrence instead of the target translational speed Vw_cmd_xy and the target turning speed ωz_cmd at the time of abnormality occurrence.

In another embodiment, the multiple legs 4 may be provided on the main body lower portion 6. In this case, another lift device different from the lift device 8 is preferably provided between the main body lower portion 6 and the multiple legs 4. In another embodiment, the lift device 8 and the legs 4 may be omitted, and the main body upper portion 7 may be joined to the main body lower portion 6 so as not to be movable up and down.

In another embodiment, only one omnidirectional wheel 3 may be included. In this case, the omnidirectional wheel 3 is preferably disposed at the center of the main body lower portion 6 in the left-right direction. Also, the omnidirectional wheel 3 is preferably disposed below the lift device 8.

The above embodiments may be described as follows.

One embodiment is a mobile body 1, comprising: a main body 2; an omnidirectional wheel 3 provided on the main body 2; and a control device 30 configured to control the omnidirectional wheel 3, wherein the control device 30 is configured to: monitor an abnormality of the mobile body 1; under normal circumstances, calculate target values including a target front-rear translational speed, a target lateral translational speed, and a target turning speed of the mobile body 1 based on inverted pendulum control and control the omnidirectional wheel 3 based on the target values; and when an abnormality is detected, stop calculation of the target values and control the omnidirectional wheel 3 for a predetermined period from detection of the abnormality, based on latest values of the target values calculated immediately before the detection of the abnormality or values obtained by gradually decreasing the latest values.

According to this aspect, it is possible to reduce the overturning moment produced when it becomes impossible to continue the inverted pendulum control in the mobile body 1. If the speeds of the omnidirectional wheels 3 are brought to 0, the speed of the lower portion of the mobile body 1 is decelerated while the upper portion of the mobile body 1 and the occupant 100 tend to keep moving due to inertia, and thus, the overturning moment increases. As a result, the time until the mobile body 1 becomes unable to stand on its own becomes short. When the mobile body 1 maintains the speed at the time of abnormality occurrence to some extent, the overturning moment is reduced and the time until the mobile body 1 becomes unable to stand on its own becomes longer. Thereby, it is possible to secure time for the occupant 100 to get off the mobile body 1 or to put his/her feet on the ground. Also, in the case where the mobile body 1 has the legs 4, it is possible to secure time for the legs 4 to come into contact with the ground.

In the above embodiment, the control device 30 may be configured to control the omnidirectional wheel 3 for the predetermined period from the detection of the abnormality based on the latest value of the target lateral translational speed calculated immediately before the detection of the abnormality, the value obtained by gradually decreasing the latest value of the target front-rear translational speed calculated immediately before the detection of the abnormality, and the value obtained by gradually decreasing the latest value of the target turning speed calculated immediately before the detection of the abnormality.

According to this aspect, the overturning moment in the left-right direction can be reduced.

In the above embodiment, the mobile body 1 may comprise: multiple legs 4 provided on the main body 2 to be displaceable between a ground contact position in which the legs 4 contact a floor surface and a retracted position in which the legs 4 are separated upward from the floor surface; and a lift device 8 for raising and lowering the legs 4 between the ground contact position and the retracted position, wherein under the normal circumstances, the control device 30 may control the lift device 8 so that the legs 4 are positioned in the retracted position, and when an abnormality is detected, the control device 30 may control the lift device 8 so that the legs 4 are moved to the ground contact position.

According to this aspect, when the mobile body 1 becomes unable to continue the inverted pendulum control, the multiple legs 4 come into contact with the ground, whereby overturning of the mobile body 1 is prevented.

Another embodiment is a control device 30 for a mobile body 1, wherein the mobile body 1 comprises a main body 2 and an omnidirectional wheel 3 provided on the main body 2, and wherein the control device 30 is configured to: monitor an abnormality of the mobile body 1; under normal circumstances, calculate target values including a target front-rear translational speed, a target lateral translational speed, and a target turning speed of the mobile body 1 based on inverted pendulum control and control the omnidirectional wheel 3 based on the target values; and when an abnormality is detected, stop calculation of the target values and control the omnidirectional wheel 3 for a predetermined period from detection of the abnormality based on latest values of the target values calculated immediately before the detection of the abnormality or values obtained by gradually decreasing the latest values.

1. A mobile body, comprising:
a main body;
an omnidirectional wheel provided on the main body; and
a control device configured to control the omnidirectional wheel,
wherein the control device is configured to:
monitor an abnormality in the mobile body;
under normal circumstances, calculate target values including a target front-rear translational speed, a target lateral translational speed, and a target turning speed of the mobile body based on inverted pendulum control and control the omnidirectional wheel based on the target values; and
when an abnormality is detected, stop calculation of the target values and control the omnidirectional wheel for a predetermined period from detection of the abnormality based on latest values of the target values calculated immediately before the detection of the abnormality or values obtained by gradually decreasing the latest values.

2. The mobile body according to claim 1, wherein the control device is configured to control the omnidirectional wheel for the predetermined period from the detection of the abnormality based on the latest value of the target lateral translational speed calculated immediately before the detection of the abnormality, the value obtained by gradually decreasing the latest value of the target front-rear translational speed calculated immediately before the detection of the abnormality, and the value obtained by gradually decreasing the latest value of the target turning speed calculated immediately before the detection of the abnormality.

3. The mobile body according to claim 1, comprising:
multiple legs provided on the main body to be displaceable between a ground contact position in which the legs contact a floor surface and a retracted position in which the legs are separated upward from the floor surface; and
a lift device for raising and lowering the legs between the ground contact position and the retracted position,
wherein under the normal circumstances, the control device controls the lift device so that the legs are positioned in the retracted position, and when the abnormality is detected, the control device controls the lift device so that the legs are moved to the ground contact position.

4. A control device for a mobile body,
wherein the mobile body comprises a main body and an omnidirectional wheel provided on the main body,
and wherein the control device is configured to:
monitor an abnormality of the mobile body;
under normal circumstances, calculate target values including a target front-rear translational speed, a target lateral translational speed, and a target turning speed of the mobile body based on inverted pendulum control and control the omnidirectional wheel based on the target values; and
when an abnormality is detected, stop calculation of the target values and control the omnidirectional wheel for a predetermined period from detection of the abnormality based on latest values of the target values calculated immediately before the detection of the abnormality or values obtained by gradually decreasing the latest values.
